(19) United States
(12) Patent Application Publication
(10) Pub. No.: US 2026/0103169 A1
(43) Pub. Date: Apr. 16, 2026

(54) METHOD FOR DETERMINING THE DISTANCE BETWEEN A VEHICLE AND EQUIPMENT CARRIED BY A USER

(71) Applicant: Continental Automotive Technologies GmbH, Hannover (DE)

(72) Inventors: Brahim ALOUI, Toulouse (FR); Fernando PINHEIRO DE VASCONCELOS, Toulouse (FR); Martin Opitz, Regensburg (DE)

(73) Assignee: Continental Automotive Technologies GmbH, Hannover (DE)

(21) Appl. No.: 19/333,151

(22) Filed: Sep. 18, 2025

(30) Foreign Application Priority Data
Sep. 19, 2024 (FR) FR2409980

(51) Int. Cl. B60R 25/24; G07C 9/00; H04B 17/318

(52) U.S. Cl. CPC B60R 25/245; G07C 9/00309; H04B 17/318; B60R 2325/101; G07C 2009/00793; G07C 2209/63

(57) ABSTRACT

The invention relates to a method for determining the distance between a communication module of a motor vehicle and a user device, said method notably comprising the steps of determining (E5) one or more quality indicators each characterizing a signal group with respect to a noise group, determining (E6) the communication module having the best quality indicator or the best combination of quality indicators, and estimating (E7) the distance between the communication module determined and the user device on the basis of the strength of signals which are exchanged between said communication module determined and said user device.

### CROSS REFERENCE TO RELATED APPLICATION

This application claims priority to French Application No. FR2409980, filed Sep. 19, 2024, the contents of such application being incorporated by reference herein.

### FIELD OF THE INVENTION

The present invention relates to the automotive field and more particularly concerns a method for determining the distance between a vehicle and a device carried by a user as well as a vehicle implementing said method.

### BACKGROUND OF THE INVENTION

It is known practice to determine the distance between a vehicle and a device carried by a user, for example a key, a fob or a telephone, when said user approaches said vehicle notably in order to trigger functions of the vehicle such as the unlocking of the opening elements or a personalized welcome.

In a known solution, the distance can be determined by measuring the strength of the signals which are exchanged with the user device. In another known solution, the distance can be determined by calculating fast Fourier transforms on the signals exchanged with the user device. In both cases, these solutions are not effective in environments where the signals are reflected multiple times such as, for example, garages or dense urban environments.

In a known solution based on the ultra-wideband (UWB) protocol, the time of flight of the signals is used to estimate the distance. However, again, the accuracy drops when the signals are reflected multiple times. Furthermore, the devices implementing the UWB protocol still remain quite expensive.

In order to remedy these drawbacks at least in part, a known solution uses the Bluetooth Low Energy (BLE) protocol and is based on an algorithm called MUSIC for “multiple signal classification”.

In this algorithm, each communication module of the vehicle which can communicate with the user device at a given instant first of all produces a bidirectional channel pulsed response on the channels of the BLE band with the user device in order to collect the phase variations of the signals. Next, a covariance matrix is calculated on the basis of the channel pulsed response produced and then the eigenvectors and the eigenvalues of said covariance matrix, which correspond to the trips of the signals made on the BLE channels, are determined.

The pseudospectrum of the covariance matrix is calculated on the basis of the eigenvectors and the eigenvalues of the matrix and then the peak having the maximum amplitude is selected, this maximum corresponding to the signal the trip of which is the most probable, which is then used to calculate the distance, the pseudospectrum being a function of the distance in a manner known per se.

A problem arises when another high-amplitude peak precedes the maximum. Indeed, this peak which is lower than the maximum can in reality correspond to the real trip rather than the maximum, which may have undergone one or more reflections, which would have increased the amplitude. In this case, the distance calculated can prove to be significantly erroneous, so that the functions of the vehicle are not activated correctly. This can notably present safety problems when a user device is detected in an area which is close to the vehicle, triggering, for example, the unlocking of the opening elements, when it is in reality further away.

A simple, reliable and effective solution which makes it possible to remedy these drawbacks at least in part would therefore be particularly advantageous.

### SUMMARY OF THE INVENTION

To this end, an aspect of the invention is first of all a method for determining the distance between a communication module of a motor vehicle and a user device, said vehicle comprising a plurality of communication modules which are each configured to communicate with said user device, said method comprising the steps of:
for each communication module of the vehicle which can communicate with the user device at a given instant: producing a bidirectional channel pulsed response on the channels of the BLE band with the user device in order to collect the phase variations of the signals, calculating a covariance matrix on the basis of the channel pulsed response produced, determining the eigenvalues of said covariance matrix corresponding to the trips of the signals which are made on the BLE channels, separating the eigenvalues into a signal group, comprising the eigenvalues the attenuation of which is below a predetermined threshold, and a noise group, comprising the eigenvalues the attenuation of which is above said predetermined threshold, determining one or more quality indicators each characterizing the signal group with respect to the noise group,
determining the communication module having the best quality indicator or the best combination of quality indicators,
estimating the distance between the communication module determined and the user device on the basis of the strength of signals which are exchanged between said communication module determined and said user device.

The method according to an aspect of the invention makes it possible to determine the most probable trip of the signals coming from the user device with high reliability and therefore to determine the distance between the vehicle and the user device in a fast, accurate, efficient and reliable manner. Reliability is achieved by using one or, preferably, more quality indices calculated on the basis of the signal group and the noise group of the eigenvalues.

In one embodiment, the communication module is determined on the basis of the best combination of quality indicators, said best combination of quality indicators being a preferably weighted average of the differences, for each type of quality indicator calculated, between the quality indicator calculated for a first communication module and the quality indicator calculated for a second communication module, the first communication module and the second communication module being the communication modules the signals of which received from the user device are the least attenuated.

In one embodiment, the communication module is determined on the basis of the best combination of quality indicators, said best combination of quality indicators being a preferably weighted cumulative average of the differences, for each type of quality indicator calculated, between the quality indicator calculated for a first communication module and the quality indicator calculated for a second communication module, the first communication module and the second communication module being the communication modules the signals of which received from the user device are the least attenuated, the average being cumulative in steps between a reference point located at a detection distance, at which the user device has been detected at a distance from the vehicle, and the vehicle.

Advantageously, a first quality indicator is equal to the difference between the lowest signal strength from among the signals corresponding to the eigenvalues of the signal group and the highest signal strength from among the signals corresponding to the eigenvalues of the noise group.

Advantageously again, a second quality indicator is equal to the ratio of the average of the strengths of the signals corresponding to the eigenvalues of the signal group to the average of the strengths of the signals corresponding to the eigenvalues of the noise group.

Advantageously again, a third quality indicator is equal to the ratio of the slope of the linear regression line of the strengths of the signals corresponding to the eigenvalues of the signal group to the slope of the linear regression line of the strengths of the signals corresponding to the eigenvalues of the noise group.

An aspect of the invention also concerns a computer program product characterized in that it comprises a set of program code instructions which, when they are executed by one or more processors, configure the one or more processors to implement a method as presented above.

An aspect of the invention also concerns a motor vehicle comprising an electronic control unit and a plurality of communication modules which are each configured to communicate with said user device, each communication module being configured to produce a bidirectional channel pulsed response on the channels of the BLE band with the user device in order to collect the phase variations of the signals, the vehicle being configured to:
calculate a covariance matrix on the basis of the channel pulsed response produced,
determine the eigenvalues of said covariance matrix corresponding to the trips of the signals which are made on the BLE channels,
separate the eigenvalues into a signal group, comprising the eigenvalues the attenuation of which is below a predetermined threshold, and a noise group, comprising the eigenvalues the attenuation of which is above said predetermined threshold,
determine one or more quality indicators each characterizing the signal group with respect to the noise group,
determine the communication module having the best quality indicator or the best combination of quality indicators,
estimate the distance between the communication module determined and the user device on the basis of the strength of signals which are exchanged between said communication module determined and said user device.

In one embodiment, the electronic control unit is configured to determine the communication module on the basis of the best combination of quality indicators, said best combination of quality indicators being a preferably weighted average of the differences, for each type of quality indicator calculated, between the quality indicator calculated for a first communication module and the quality indicator calculated for a second communication module, the first communication module and the second communication module being the communication modules the signals of which received from the user device are the least attenuated.

In one embodiment, the electronic control unit is configured to determine the communication module on the basis of the best combination of quality indicators, said best combination of quality indicators being a preferably weighted cumulative average of the differences, for each type of quality indicator calculated, between the quality indicator calculated for a first communication module and the quality indicator calculated for a second communication module, the first communication module and the second communication module being the communication modules the signals of which received from the user device are the least attenuated, the average being cumulative in steps between a reference point located at a detection distance, at which the user device has been detected at a distance from the vehicle, and the vehicle.

### BRIEF DESCRIPTION OF THE DRAWINGS

Other features and advantages of aspects of the invention will become more clearly apparent upon reading the following description. This is purely illustrative and must be read with reference to the appended drawings, in which:

FIG. 1 schematically illustrates one embodiment of the system according to the invention.

FIG. 2 schematically illustrates one embodiment of the method according to the invention.

FIG. 3 illustrates one example of a first quality indicator.

FIG. 4 illustrates one example of a second quality indicator.

FIG. 5 illustrates one example of a third quality indicator.

FIG. 6 illustrates a first configuration of a user device with respect to the vehicle.

FIG. 7 illustrates the evolution of the first quality indicator, of the second quality indicator and of the third quality indicator as a function of distance for the configuration of FIG. 6.

FIG. 8 illustrates, on the left, the evolution of the average and of the cumulative average of the first quality indicator, of the second quality indicator and of the third quality indicator as a function of distance for the configuration of FIG. 6 and, on the right, the error as a function of distance.

FIG. 9 illustrates a second configuration of a user device with respect to the vehicle.

FIG. 10 illustrates the evolution of the first quality indicator, of the second quality indicator and of the third quality indicator as a function of distance for the configuration of FIG. 9.

FIG. 11 illustrates, on the left, the evolution of the average and of the cumulative average of the first quality indicator, of the second quality indicator and of the third quality indicator as a function of distance for the configuration of FIG. 9 and, on the right, the error as a function of distance.

FIG. 12 illustrates a third configuration of a user device with respect to the vehicle.

FIG. 13 illustrates the evolution of the first quality indicator, of the second quality indicator and of the third quality indicator as a function of distance for the configuration of FIG. 12.

FIG. 14 illustrates, on the left, the evolution of the average and of the cumulative average of the first quality indicator, of the second quality indicator and of the third quality indicator as a function of distance for the configuration of FIG. 12 and, on the right, the error as a function of distance.

FIG. 15 illustrates a fourth configuration of a user device with respect to the vehicle.

FIG. 16 illustrates the evolution of the first quality indicator, of the second quality indicator and of the third quality indicator as a function of distance for the configuration of FIG. 15.

FIG. 17 illustrates, on the left, the evolution of the average and of the cumulative average of the first quality indicator, of the second quality indicator and of the third quality indicator as a function of distance for the configuration of FIG. 15 and, on the right, the error as a function of distance.

FIG. 18 illustrates a fifth configuration of a user device with respect to the vehicle.

FIG. 19 illustrates the evolution of the first quality indicator, of the second quality indicator and of the third quality indicator as a function of distance for the configuration of FIG. 18.

FIG. 20 illustrates, on the left, the evolution of the average and of the cumulative average of the first quality indicator, of the second quality indicator and of the third quality indicator as a function of distance for the configuration of FIG. 18 and, on the right, the error as a function of distance.

FIG. 21 illustrates a sixth configuration of a user device with respect to the vehicle.

FIG. 22 illustrates the evolution of the first quality indicator, of the second quality indicator and of the third quality indicator as a function of distance for the configuration of FIG. 21.

FIG. 23 illustrates, on the left, the evolution of the average and of the cumulative average of the first quality indicator, of the second quality indicator and of the third quality indicator as a function of distance for the configuration of FIG. 21 and, on the right, the error as a function of distance.

### DETAILED DESCRIPTION OF EXEMPLARY EMBODIMENTS

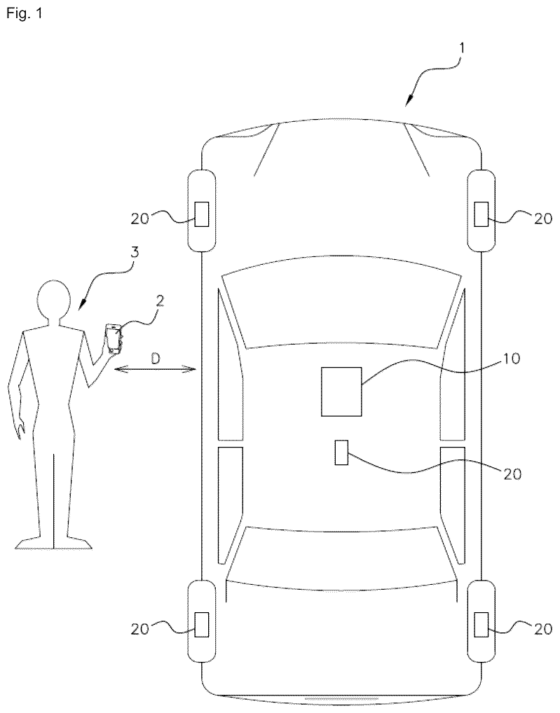

FIG. 1 illustrates one example of a motor vehicle 1 according to an aspect of the invention and of a user device 2 carried by a user 3 and located at a distance D from the vehicle 1.

The vehicle 1 comprises an electronic control unit 10 and a plurality of communication modules 20, for example five communication modules 20 arranged in the corners of the vehicle 1 and in its middle, in a manner known per se.

Each communication module 20 comprises a transceiver antenna and is configured to communicate with the user device 2 over a Bluetooth Low Energy (BLE) wireless communication link. BLE communication is performed on 80 channels in a frequency band between 2.4 GHz and 2.4835 GHz.

Each communication module 20 is configured to produce, for example on the command of the electronic control unit 10, a bidirectional channel pulsed response on the channels of the BLE band with the user device 2. Such a bidirectional channel pulsed response consists, on each channel of the BLE band, in transmitting signals to the user device 2 and in receiving the signals sent in response by the user device 2 and then in determining the phase variations between said transmitted signals and said received signals.

Each communication module 20 is configured to calculate a covariance matrix on the basis of the channel pulsed response produced by said communication module 20. As a variant, the electronic control unit 10 can be configured, for each of the communication modules 20, to calculate a covariance matrix on the basis of the channel pulsed response produced by said communication module 20.

Each communication module 20 is configured to determine the eigenvalues VP, with reference to FIGS. 3 to 5, of said covariance matrix corresponding to the trips of the signals which are made on the BLE channels. As a variant, the electronic control unit 10 can be configured to, for each of the communication modules 20, determine the eigenvalues VP of said covariance matrix corresponding to the trips of the signals which are made on the BLE channels. Determining the eigenvalues VP is a process known per se to a person skilled in the art.

Each communication module 20 is configured to separate the eigenvalues VP into a signal group GS, comprising the eigenvalues VP the attenuation of which is below a predetermined threshold, and a noise group GB, comprising the eigenvalues VP the attenuation of which is above said predetermined threshold. As a variant, the electronic control unit 10 can be configured to, for each of the communication modules 20, separate the eigenvalues VP into, on one hand, a signal group GS, comprising the eigenvalues VP the attenuation of which is below a predetermined threshold, and, on the other hand, a noise group GB, comprising the eigenvalues VP the attenuation of which is above said predetermined threshold.

The eigenvalues VP of the signal group GS correspond to the trips of the signals between a communication module 20 and the user device 2 which are the most probable because their strength has not been attenuated much during the round trip, for example because the trip is direct (without reflection off an object or a person) or comprises few reflections off an object or a person, for example one or two reflections at most. The eigenvalues VP of the noise group GB correspond to the trips of the signals which have undergone numerous reflections, for example more than two, or originate from third-party sources, so that the strength of the signals has been highly attenuated (i.e. below the predetermined threshold) and so that these trips are thus not representative of the real distance between the communication module 20 and the user device 2 because of the long distance which they have traveled.

Each communication module 20 is configured to determine one or more quality indicators IQ1, IQ2, IQ3 each characterizing the signal group with respect to the noise group. As a variant, the electronic control unit 10 can be configured to, for each of the communication modules 20, determine one or more quality indicators IQ1, IQ2, IQ3 each characterizing the signal group GS with respect to the noise group GB.

FIGS. 3 to 5 depict three examples of energy E in dB of eigenvalues VP (limited to 50 for reasons of clarity) for determining three given quality indicators IQ1, IQ2, IQ3.

A first quality indicator IQ1, one example of which is given in FIG. 3, corresponds to the difference between the lowest signal strength from among the signals corresponding to the eigenvalues VP of the signal group GS and the highest signal strength from among the signals corresponding to the eigenvalues VP of the noise group GB.

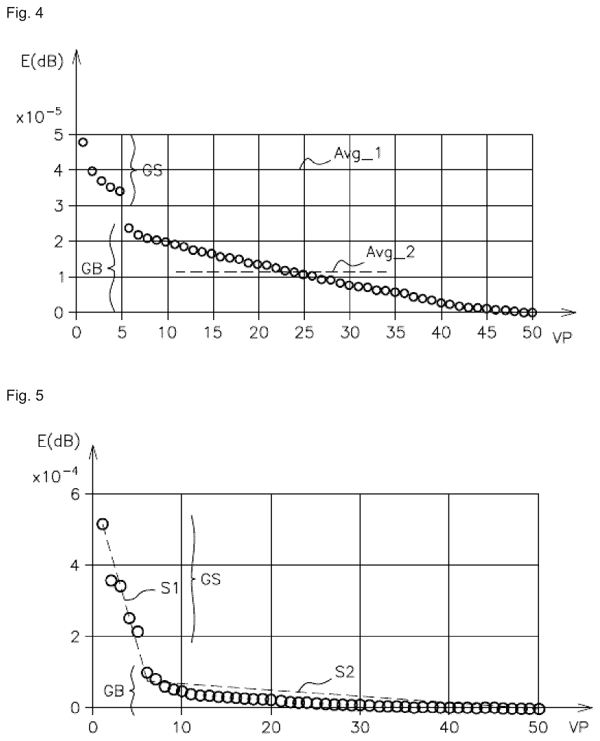

A second quality indicator IQ2, one example of which is given in FIG. 4, corresponds to the ratio of the average of the strengths of the signals corresponding to the eigenvalues VP of the signal group GS to the average of the strengths of the signals corresponding to the eigenvalues VP of the noise group GB.

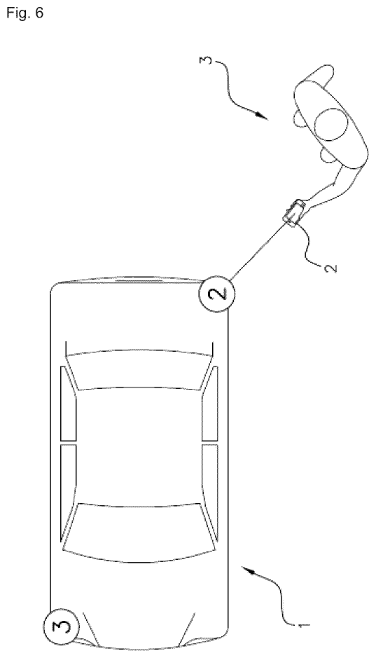

A third quality indicator IQ3, one example of which is given in FIG. 5, corresponds to the ratio of the slope of the linear regression line of the strengths of the signals corresponding to the eigenvalues VP of the signal group GS to the slope of the linear regression line of the strengths of the signals corresponding to the eigenvalues VP of the noise group GB.

The electronic control unit 10 is configured to determine the communication module 20 having the best quality indicator IQ1, IQ2, IQ3 or the best combination of quality indicators IQ1, IQ2, IQ3 and estimate the distance D between the communication module 20 determined and the user device 2 on the basis of the strength of signals which are exchanged between said communication module 20 determined and said user device 2.

Preferably, a combination of the three quality indicators IQ1, IQ2, IQ3 is used. As a variant, a single quality indicator IQ1, IQ2, IQ3 could be used, preferably one of the first quality indicator IQ1, the second quality indicator IQ2 or the third quality indicator IQ3.

The combination of quality indicators IQ1, IQ2, IQ3 can be an average, which is notably weighted as a function of the best performance of these quality indicators (which is extracted from the various characterizations in various environments), of the differences, for each type of quality indicator IQ1, IQ2, IQ3 calculated, between the quality indicator IQ1, IQ2, IQ3 calculated for a first communication module 20 and the quality indicator IQ1, IQ2, IQ3 calculated for a second communication module 20, the first communication module 20 and the second communication module 20 being the communication modules 20 the signals of which received from the user device 2 are the least attenuated.

The combination of quality indicators IQ1, IQ2, IQ3 is a cumulative average, which is notably weighted as a function of the best performance of these quality indicators (which is extracted from the various characterizations in various environments), of the differences, for each type of quality indicator IQ1, IQ2, IQ3 calculated, between the quality indicator IQ1, IQ2, IQ3 calculated for a first communication module 20 and the quality indicator IQ1, IQ2, IQ3 calculated for a second communication module 20, the first communication module 20 and the second communication module 20 being the communication modules 20 the signals of which received from the user device 2 are the least attenuated, the average being cumulative in steps between a reference point located at a detection distance, at which the user device 2 has been detected at a distance from the vehicle 1, and the vehicle 1.

The user device 2 comprises a processor configured to implement a set of instructions making it possible to perform the functions mentioned.

Likewise, each communication module 20 comprises a processor configured to implement a set of instructions making it possible to perform the functions mentioned.

Likewise, the electronic control unit 10 comprises a processor configured to implement a set of instructions making it possible to perform the functions mentioned.

Moreover, the user device 2, the electronic control unit 10 and each communication module 20 can notably cooperate with a computer comprising computing and memory means which are suitable for implementing all of the method steps, instructions and calculations mentioned.

### EXAMPLES OF IMPLEMENTATION

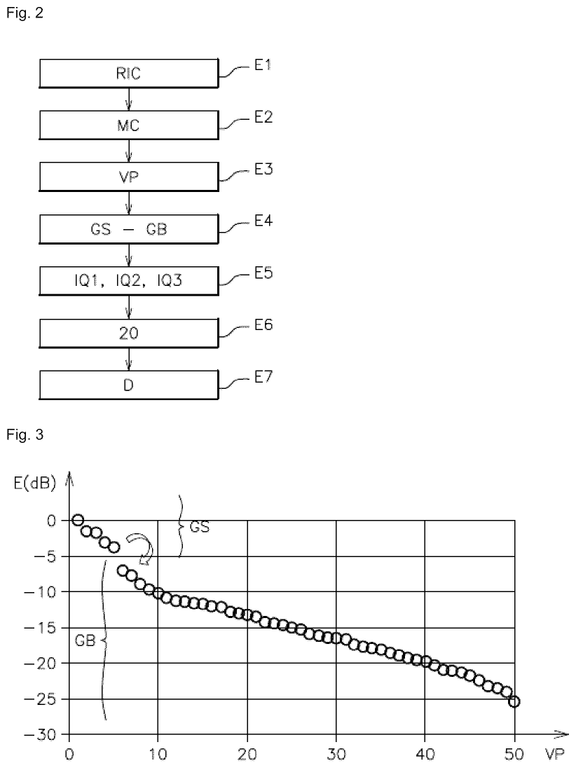

With reference to FIG. 2, in a step E1, each communication module 20 which can communicate with the user device 2 at a given instant, that is to say which is in the BLE coverage of said user device 20, produces a bidirectional channel pulsed response RIC on the channels of the BLE band with said user device 2 in order to collect the phase variations of the signals.

In a step E2, each communication module 20 calculates a covariance matrix MC on the basis of the channel pulsed response RIC produced and then determines, in a step E3, the eigenvalues VP of said covariance matrix MC corresponding to the trips of the signals which are made on the BLE channels.

Next, in a step E4, each communication module 20 separates the eigenvalues VP between a signal group GS, comprising the eigenvalues VP the attenuation of which is below a predetermined threshold, and a noise group GB, comprising the eigenvalues VP the attenuation of which is above said predetermined threshold.

Next, in a step E5, each communication module 20 determines one or more quality indicators IQ1, IQ2, IQ3 each characterizing the signal group GS with respect to the noise group GB.

FIG. 3 illustrates one example of the energy of the eigenvalues (in dB) as a function of said eigenvalues. In this example, a first quality indicator IQ1 corresponds to the difference between the lowest signal strength from among the signals corresponding to the eigenvalues VP of the signal group GS and the highest signal strength from among the signals corresponding to the eigenvalues VP of the noise group GB.

FIG. 4 illustrates one example of the energy of the eigenvalues as a function of said eigenvalues. In this example, a second quality indicator IQ2 corresponds to the ratio of the average Avg_1 of the strengths of the signals corresponding to the eigenvalues VP of the signal group GS to the average Avg_2 of the strengths of the signals corresponding to the eigenvalues VP of the noise group GB.

FIG. 5 illustrates one example of the energy of the eigenvalues as a function of said eigenvalues. In this example, a third quality indicator IQ3 corresponds to the ratio of the slope S1 of the linear regression line of the strengths of the signals corresponding to the eigenvalues VP of the signal group GS to the slope S2 of the linear regression line of the strengths of the signals corresponding to the eigenvalues VP of the noise group GB.

Once the steps E1 to E5 have been performed for each communication module 20 which can communicate with the user device 2, the electronic control unit 10 determines, in a step E6, the communication module 20 having the best quality indicator IQ1, IQ2, IQ3 or the best combination of quality indicators IQ1, IQ2, IQ3.

For example, a combination Comb_QI of quality indicators IQ1, IQ2, IQ3 can be the average of the quality indicators IQ1, IQ2, IQ3 for a given distance:

$$Comb\_QI = \frac{α . {Δ}_{2 , 3} {QI}_{1} + β . {Δ}_{2 , 3} {QI}_{2} + γ . {Δ}_{2 , 3} {QI}_{3}}{3} \qquad [ Math 1 ]$$

where α=β=γ1, for example (or any other suitable values, for example determined empirically as a function of the best performance of these quality indicators, which are notably extracted from the various characterizations in various environments).

For example again, a combination Cumul_Sum of quality indicators IQ1, IQ2, IQ3 can be the sum of the averages of the quality indicators IQ1, IQ2, IQ3 for discrete distance values within a given distance range around the vehicle 1, for example between 0 and 5 m with a pitch of 0.5 m:

$$Cumul\_Sum = \frac{α . {Δ}_{2 , 3} {QI}_{1 , k} + β . {Δ}_{2 , 3} {QI}_{2 , k} + γ . {Δ}_{2 , 3} {QI}_{3 , k}}{3} \qquad [ Math 2 ]$$

where α=β=γ=1, for example (or any other suitable values, for example determined empirically as a function of the best performance of these quality indicators, which are notably extracted from the various characterizations in various environments).

The electronic control unit 10 finally estimates, in a step E7, the distance D between the communication module 20 determined and the user device 2 on the basis of the strength of signals which are exchanged between said communication module 20 determined and said user device 2. Since this determination is known per se to a person skilled in the art, it will not be described in further detail here.

### Examples of Simulations

FIGS. 6, 9, 12, 15, 18 and 21 illustrate six different arrangements of a user device 2 with respect to the user 3 and to the vehicle 1.

In the first configuration, illustrated in FIG. 6, the user device 2 is held in the hand of the user 3 in a position referred to as the “surf” position (i.e. substantially horizontally) and is at about 45° with respect to a communication module numbered 2 and called an “anchor 2”, the vehicle 1 comprising a communication module numbered 3 and called an “anchor 3” located opposite.

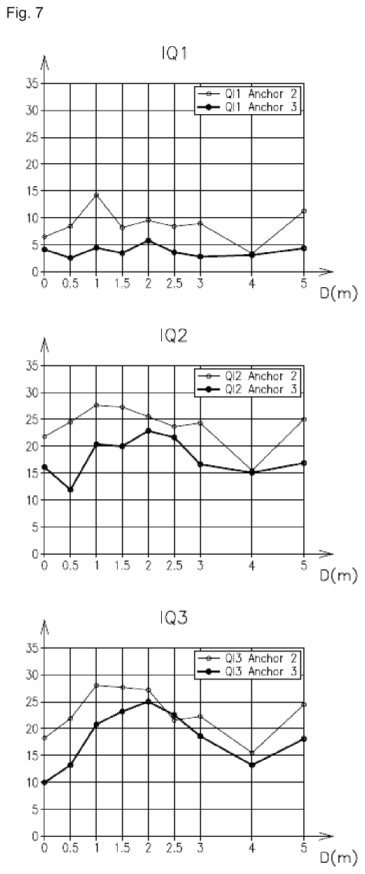

With reference to FIG. 7, it appears that the first quality indicator IQ1, the second quality indicator IQ2 and the third quality indicator IQ3 are higher for the anchor 2 than for the anchor 3 with an accuracy of 100%, 100% and 88.89%, respectively.

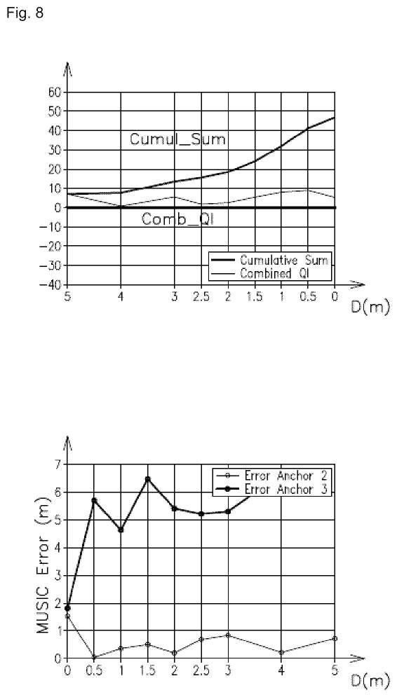

With reference to FIG. 8, it appears that the combination Comb_QI of quality indicators IQ1, IQ2, IQ3 is positive whatever the distance and that the combination Cumul_Sum of quality indicators IQ1, IQ2, IQ3 grows with distance, which confirms that the anchor 2 is in direct view with respect to the anchor 3 and that it must therefore be used to calculate the distance D between the vehicle 1 and the user device 2, with an accuracy of 100% and 100%, respectively. It can furthermore be seen that the error is larger on the anchor 3 than on the anchor 2 (FIG. 8, right-hand graph).

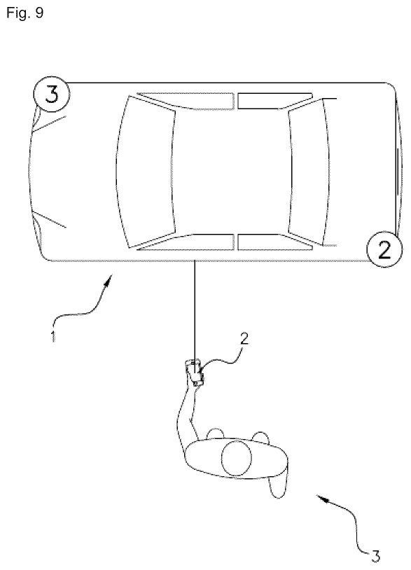

In the second configuration, illustrated in FIG. 9, the user device 2 is held in the hand of the user 3 in a position referred to as the “surf” position (i.e. substantially horizontally) and is at about 90° with respect to a communication module numbered 2 and called an “anchor 2”, the vehicle 1 comprising a communication module numbered 3 and called an “anchor 3” located opposite to the left.

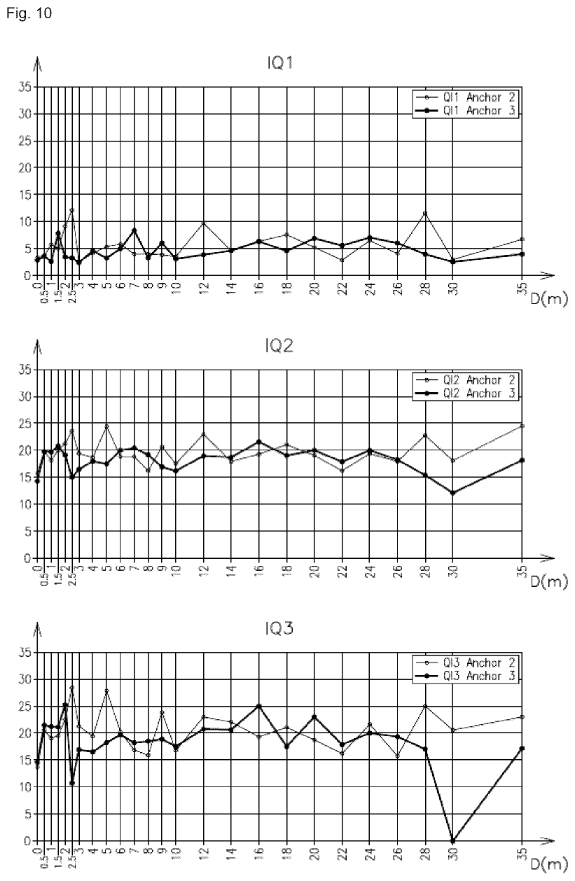

With reference to FIG. 10, it appears that the first quality indicator IQ1, the second quality indicator IQ2 and the third quality indicator IQ3 appear to be higher for the anchor 2 than for the anchor 3 but with curve inversions and an accuracy of 68%, 52% and 52%, respectively.

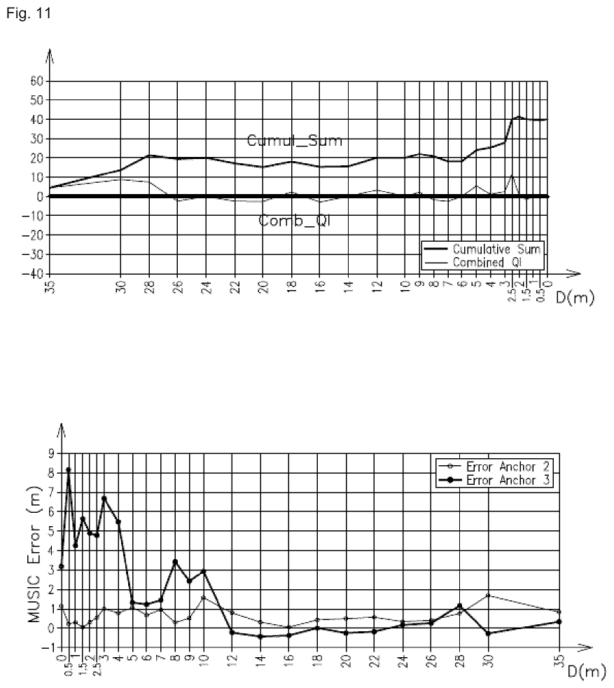

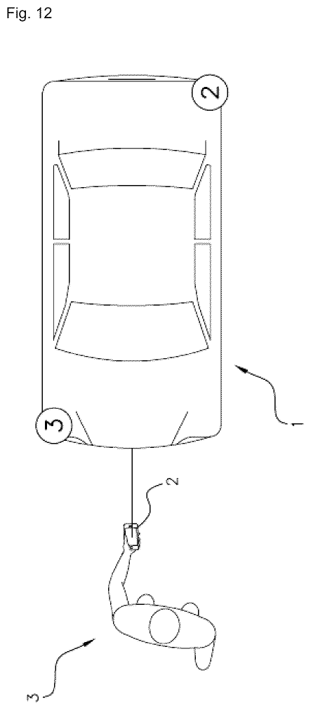

With reference to FIG. 11, it appears that the combination Comb_QI of quality indicators IQ1, IQ2, IQ3 is positive and then oscillates around zero when the distance increases and the combination Cumul_Sum of quality indicators IQ1, IQ2, IQ3 grows with distance, which confirms that the anchor 2 is in direct view with respect to the anchor 3 and that it must therefore be used to calculate the distance D between the vehicle 1 and the user device 2, with an accuracy of 60% and 100%, respectively. It can furthermore be seen that the MUSIC error Error (FIG. 11, right-hand graph) is larger on the anchor 3 than on the anchor 2 when the distance is small and then that the error on the anchor 2 and the error on the anchor 3 are similar at larger distances.

In the third configuration, illustrated in FIG. 12, the user device 2 is held in the hand of the user 3 in a position referred to as the “surf” position (i.e. substantially horizontally) and is at about 180° with respect to the anchor 2, the anchor 3 being located to the left.

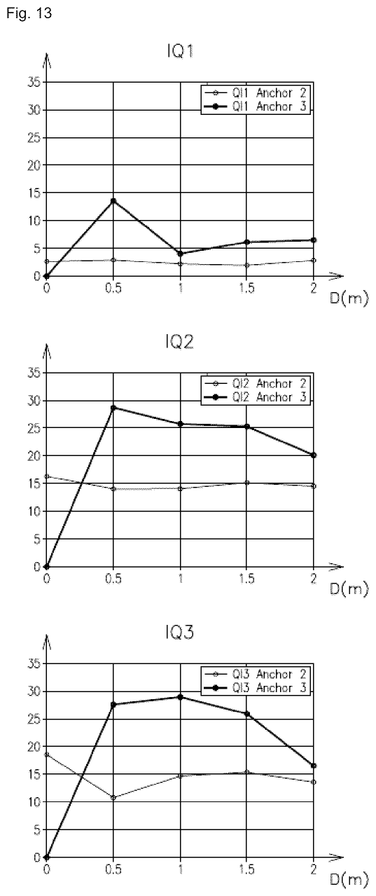

With reference to FIG. 13, it appears that the first quality indicator IQ1, the second quality indicator IQ2 and the third quality indicator IQ3 appear to be higher for the anchor 3 than for the anchor 2 except at small distances and with an accuracy of 80%, 80% and 80%, respectively.

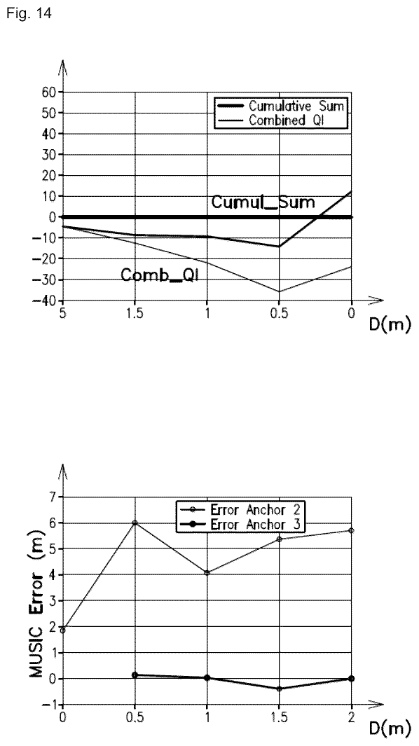

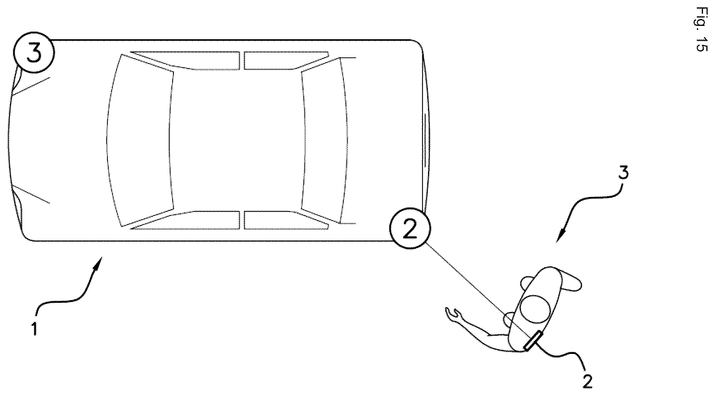

With reference to FIG. 14, it appears that the combination Comb_QI of quality indicators IQ1, IQ2, IQ3 is negative and then positive when the distance increases and the combination Cumul_Sum of quality indicators IQ1, IQ2, IQ3 decreases with distance and then grows while remaining below the combination Comb_QI of quality indicators IQ1, IQ2, IQ3, which confirms that the anchor 3 is in direct view with respect to the anchor 2 and that it must therefore be used to calculate the distance D between the vehicle 1 and the user device 2, with an accuracy of 80% and 100%, respectively. It can furthermore be seen that the MUSIC error Error is larger on the anchor 2 than on the anchor 3 (FIG. 14, right-hand graph).

In the fourth configuration, illustrated in FIG. 15, the user device 2 is placed in the back pocket of the user 3 and is at approximately 45° with respect to the anchor 2, the anchor 3 being located opposite.

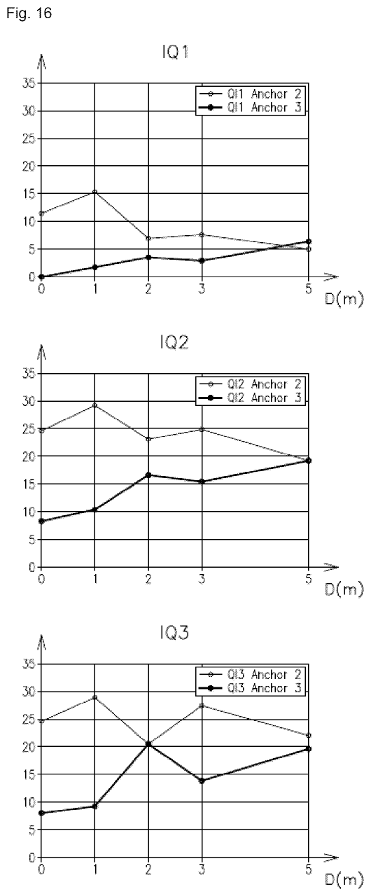

With reference to FIG. 16, it appears that the first quality indicator IQ1, the second quality indicator IQ2 and the third quality indicator IQ3 are higher for the anchor 2 than for the anchor 3 with an accuracy of 80%, 100% and 100%, respectively.

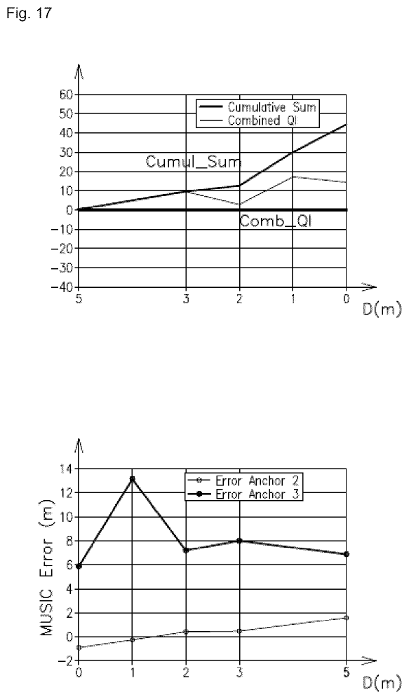

With reference to FIG. 17, it appears that the combination Comb_QI of quality indicators IQ1, IQ2, IQ3 is positive whatever the distance and that the combination Cumul_Sum of quality indicators IQ1, IQ2, IQ3 grows with distance, which confirms that the anchor 2 is in direct view with respect to the anchor 3 and that it must therefore be used to calculate the distance D between the vehicle 1 and the user device 2, with an accuracy of 100% and 100%, respectively. It can furthermore be seen that the error is larger on the anchor 3 than on the anchor 2 (FIG. 17, right-hand graph).

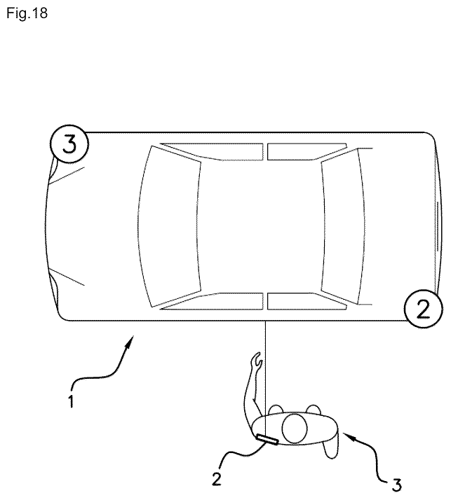

In the fifth configuration, illustrated in FIG. 18, the user device 2 is placed in the back pocket of the user 3 and is at about 90° with respect to the anchor 2, the anchor 3 being located opposite to the left.

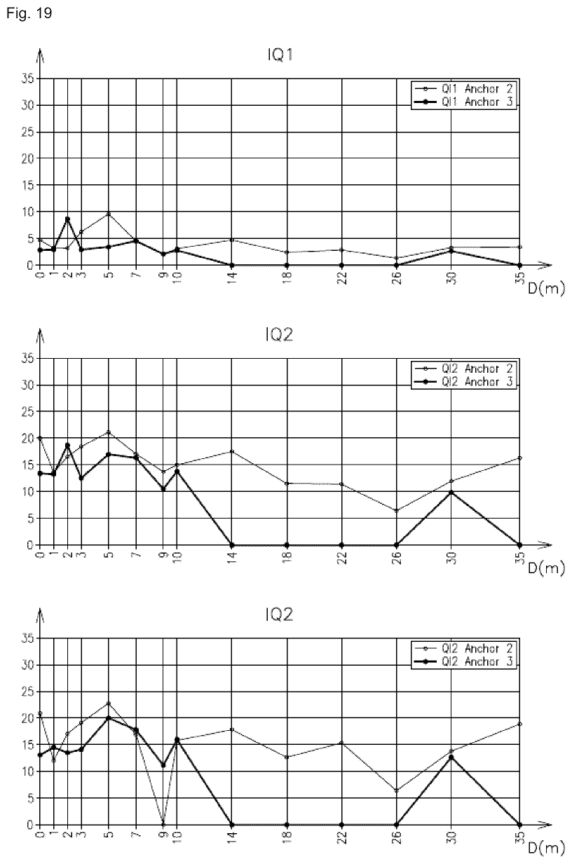

With reference to FIG. 19, it appears that the first quality indicator IQ1, the second quality indicator IQ2 and the third quality indicator IQ3 appear to be higher for the anchor 2 than for the anchor 3 but with curve inversions and an accuracy of 92.86%, 92.86% and 78.57%, respectively.

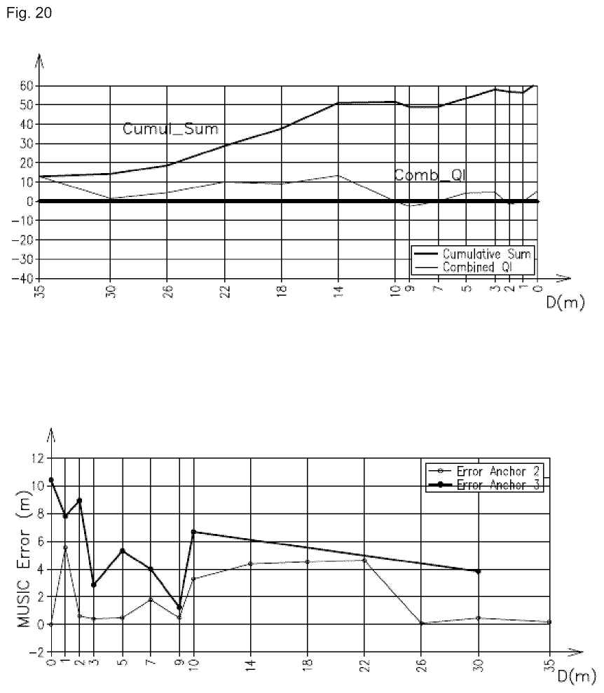

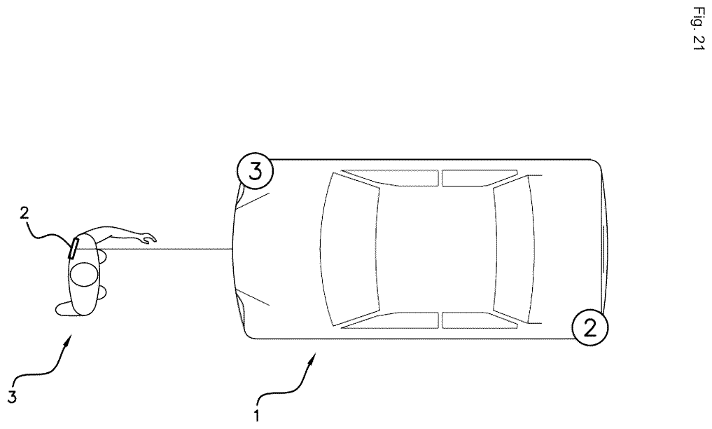

With reference to FIG. 20, it appears that the combination Comb_QI of quality indicators IQ1, IQ2, IQ3 is positive and then oscillates around zero when the distance increases and the combination Cumul_Sum of quality indicators IQ1, IQ2, IQ3 grows when the distance decreases, which confirms that the anchor 2 is in direct view with respect to the anchor 3 and that it must therefore be used to calculate the distance D between the vehicle 1 and the user device 2, with an accuracy of 78.6% and 100%, respectively. It can furthermore be seen that the error is larger on the anchor 3 than on the anchor 2 when the distance is small and then that the error on the anchor 2 and the error on the anchor 3 are similar at larger distances (FIG. 20, right-hand graph).

In the sixth configuration, illustrated in FIG. 21, the user device 2 is placed in the back pocket of the user 3 and is at about 180° with respect to the anchor 2, the anchor 3 being located to the left.

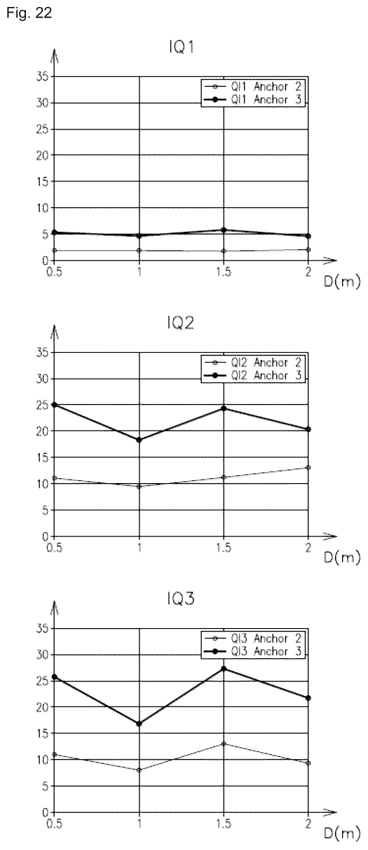

With reference to FIG. 22, it appears that the first quality indicator IQ1, the second quality indicator IQ2 and the third quality indicator IQ3 appear to be higher for the anchor 3 than for the anchor 2 except at small distances and with an accuracy of 100%, 100% and 100%, respectively.

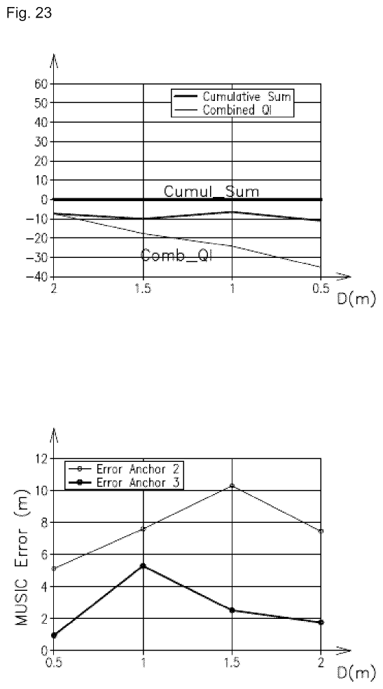

With reference to FIG. 23, it appears that the combination Comb_QI of quality indicators IQ1, IQ2, IQ3 is negative when the distance increases and the combination Cumul_Sum of quality indicators IQ1, IQ2, IQ3 decreases with distance and then grows while remaining negative, which confirms that the anchor 3 is in direct view with respect to the anchor 2 and that it must therefore be used to calculate the distance D between the vehicle 1 and the user device 2, with an accuracy of 100% and 100%, respectively. It can furthermore be seen that the error is larger on the anchor 2 than on the anchor 3 (FIG. 23, right-hand graph).

1. A method for determining the distance between a communication module of a motor vehicle and a user device, said vehicle comprising a plurality of communication modules which are each configured to communicate with said user device, said method comprising the steps of:
for each communication module of the vehicle which can communicate with the user device at a given instant:
producing a bidirectional channel pulsed response on channels of the BLE band with the user device in order to collect the phase variations of the signals,
calculating a covariance matrix on the basis of the channel pulsed response produced,
determining the eigenvalues of said covariance matrix corresponding to the trips of the signals which are made on the BLE channels,
separating the eigenvalues into a signal group, comprising the eigenvalues the attenuation of which is below a predetermined threshold, and a noise group, comprising the eigenvalues the attenuation of which is above said predetermined threshold,
determining one or more quality indicators each characterizing the signal group with respect to the noise group,
determining the communication module having the best quality indicator or the best combination of quality indicators,
estimating the distance between the communication module determined and the user device on the basis of the strength of signals which are exchanged between said communication module determined and said user device.

2. The method as claimed in claim 1, wherein the communication module is determined on the basis of the best combination of quality indicators, said best combination of quality indicators being an average of the differences, for each type of quality indicator calculated, between the quality indicator calculated for a first communication module and the quality indicator calculated for a second communication module, the first communication module and the second communication module being the communication modules the signals of which received from the user device are the least attenuated.

3. The method as claimed in claim 1, wherein the communication module is determined on the basis of the best combination of quality indicators, said best combination of quality indicators being a cumulative average of the differences, for each type of quality indicator calculated, between the quality indicator calculated for a first communication module and the quality indicator calculated for a second communication module, the first communication module and the second communication module being the communication modules the signals of which received from the user device are the least attenuated, the average being cumulative in steps between a reference point located at a detection distance, at which the user device has been detected at a distance from the vehicle, and the vehicle.

4. The method as claimed in claim 1, wherein a first quality indicator is equal to the difference between the lowest signal strength among the signals corresponding to the eigenvalues of the signal group and the highest signal strength from among the signals corresponding to the eigenvalues of the noise group.

5. The method as claimed in claim 1, wherein a second quality indicator is equal to the ratio of the average of the strengths of the signals corresponding to the eigenvalues of the signal group to the average of the strengths of the signals corresponding to the eigenvalues of the noise group.

6. The method as claimed in claim 1, wherein a third quality indicator is equal to the ratio of the slope of the linear regression line of the strengths of the signals corresponding to the eigenvalues of the signal group to the slope of the linear regression line of the strengths of the signals corresponding to the eigenvalues of the noise group.

7. A non-transitory computer program product, comprising a set of program code instructions which, when they are executed by one or more processors, configure the one or more processors to implement a method as claimed in claim 1.

8. A motor vehicle comprising an electronic control unit and a plurality of communication modules which are each configured to communicate with said user device, each communication module being configured to produce a bidirectional channel pulsed response on the channels of the BLE band with the user device in order to collect the phase variations of the signals, the vehicle being configured to:
calculate a covariance matrix on the basis of the channel pulsed response produced,
determine the eigenvalues of said covariance matrix corresponding to the trips of the signals which are made on the BLE channels,
separate the eigenvalues into a signal group, comprising the eigenvalues the attenuation of which is below a predetermined threshold, and a noise group, comprising the eigenvalues the attenuation of which is above said predetermined threshold,
determine one or more quality indicators each characterizing the signal group with respect to the noise group,
determine the communication module having the best quality indicator or the best combination of quality indicators,
estimate the distance between the communication module determined and the user device on the basis of the strength of signals which are exchanged between said communication module determined and said user device.

9. The vehicle as claimed in claim 8, wherein the electronic control unit is configured to determine the communication module on the basis of the best combination of quality indicators, said best combination of quality indicators being an average of the differences, for each type of quality indicator, calculated, between the quality indicator calculated for a first communication module and the quality indicator calculated for a second communication module, the first communication module and the second communication module being the communication modules the signals of which received from the user device are the least attenuated.

10. The vehicle as claimed in claim 9, wherein the electronic control unit is configured to determine the communication module on the basis of the best combination of quality indicators, said best combination of quality indicators being a cumulative average of the differences, for each type of quality indicator calculated, between the quality indicator calculated for a first communication module and the quality indicator calculated for a second communication module, the first communication module and the second communication module being the communication modules the signals of which received from the user device are the least attenuated, the average being cumulative in steps between a reference point located at a detection distance, at which the user device has been detected at a distance from the vehicle, and the vehicle.
